(19) United States
(12) Patent Application Publication
(10) Pub. No.: US 2011/0261672 A1
(43) Pub. Date: Oct. 27, 2011

(54) OPTICALLY WRITABLE HOLOGRAPHIC MEDIA

(75) Inventor: Christopher J. Dyball, Half Moon Bay, CA (US)

(73) Assignee: LASERCARD CORPORATION, Mountain View, CA (US)

(21) Appl. No.: 12/941,890

(22) Filed: Nov. 8, 2010

Related U.S. Application Data
(60) Provisional application No. 61/327,581, filed on Apr. 23, 2010.

(51) Int. Cl. G11B 7/26

(52) U.S. Cl. 369/283; G9B/7.194

(57) ABSTRACT

An optically writable holographic card, an optically writable holographic media, and a method of making the media are herein described. The card has a media region that includes an optically writable material. The optically writable material has an holographic embossment such that an holographic image is producible by the optically writable material. The media includes an holographically embossed first layer. An optically writable, optically readable second layer conforms to the embossment. The holographic image is generable by the second layer. The method includes producing an holographic embossment associated with an holographic image. An optically writable layer is conformed to the holographic embossment. The holographic image is viewable in response to illuminating the optically writable layer. The optically writable layer is optically readable. The optically writable material on the card may support optically written digital data and an optically written image, or an optically written image having embedded digital data.

### CROSS-REFERENCE TO RELATED APPLICATION

This application claims priority from U.S. provisional patent application Ser. No. 61/327,581, filed April 23, 2010.

### TECHNICAL FIELD

The present invention relates generally to holograms, identification cards and optically writable media, and more specifically to optical secure media cards.

### BACKGROUND

Current optical card technology provides very high quality polycarbonate card products capable of optically recording (writing) digital data in the range of 1-2.5 megabytes per card, which can also support the optical recording (writing) of high resolution visual imagery up to 24,000 dots per inch (dpi) or about 9400 dots per centimeter. A laser imaged identification card is described in U.S. Pat. No. 5,421,619, to Dyball, with the card having a strip of reflective optical recording material. In a known current design, an optical secure media (OSM) card includes an optically writable/optically readable strip of 16 to 35 millimeter width along the entire length of the OSM card, and is writable and readable using a desktop OSM reader writer system costing under $5,000. Such OSM cards, i.e. cards having optically writable regions, are widely regarded as the most fraud resistant cards available due to the difficulty of their replication. In particular, the optically written high resolution visual image has presented a very high barrier to forgers and is the primary feature that caused many customers to select the OSM card. Data storage size has generally proved to be a secondary consideration.

Widespread adoption of the OSM card has been limited however due to the relatively high cost of the technology when compared to simple plastic cards, and the limitations of the form factor of the OSM.

A further known system for personalizing identification cards uses laser engraving for plastic cards. Laser engraving is not equivalent to optical writing, and is applicable to a wide variety of materials not considered optically writable. Currently available YAG laser engravers cost $50,000 and up. Laser engravers use higher power lasers than optical writing lasers, as laser engravers carbonize plastic or other materials when engraving.

Development of a media that is more secure than current laser engraving and uses a less expensive machine for personalizing would be applicable to a wide range of card products. A low cost media with personalized security features would make decentralized issuance of personalized cards a viable alternative to the centralized issue schemes for which laser engraving is normally reserved. Such a media would also compete with emerging personalized hologram machines (Hologram Industries and others) which sell for over $500,000 and have relatively high consumables costs.

### SUMMARY

In an optically writable holographic card and related optically writable holographic media, an optically writable material is used for making an embossed hologram. An optically writable layer or material substitutes for the known reflective layer in the embossed hologram. In common with the known embossed hologram, and in contrast with known optically writable media and known optically writable cards, the optically writable holographic media and the optically writable holographic card can generate an holographic image, as a consequence of the optically writable material having an holographic embossment. By contrast with the known embossed hologram that is not optically writable, the optically writable holographic media and optically writable holographic card support optical writing of data and optical writing of images on an holographically embossed optically writable material.

An optically writable holographic card is herein described. An optically writable holographic media, suitable for use in the optically writable holographic card, is described. A method of making an optically writable holographic media is described.

In the method, an holographic embossment associated with an holographic image is produced. An optically writable layer is conformed to the holographic embossment. In response to illuminating the optically writable layer, the holographic image is viewable. The optically writable layer may contain digital data that is optically readable and/or images that are viewable by eye.

An optically writable holographic media has a first layer and a second layer. The holographically embossed first layer has an embossment corresponding to an holographic image. The optically writable, optically readable second layer conforms to the embossment. The holographic image is generable by the optically writable second layer.

An optically writable holographic card includes a card and a media region on the card. The media region includes an optically writable material having an holographic embossment. An holographic image related to the holographic embossment is producible by the optically writable material.

### BRIEF DESCRIPTION OF THE DRAWINGS

FIG. 1 is an elevated view of an optically writable holographic card using an optically writable holographic media, in accordance with the present invention.

FIG. 2 is a cross-section view of layers in an existing process for an embossed hologram.

FIG. 3 is a perspective view of an existing system that releases an embossed hologram from a polyester support and thermally bonds the embossed hologram to a substrate.

FIG. 4 is a cross-section view of layers in an optically writable holographic media, having an holographic embossment and suitable for use in the optically writable holographic card of FIG. 1.

FIG. 5 is a cross-section view of layers in an optically writable holographic media having an holographic embossment as a variation of the layers of FIG. 4, and suitable for use in the optically writable holographic card of FIG. 1.

FIG. 6 is a cross-section view of layers in an optically writable holographic media, adhered to a transparent layer and released from a release layer, and suitable for use in the optically writable holographic card of FIG. 1.

FIG. 7 is an elevated view of an optically writable holographic card that is a variation of the optically writable holographic card of FIG. 1.

### DETAILED DESCRIPTION

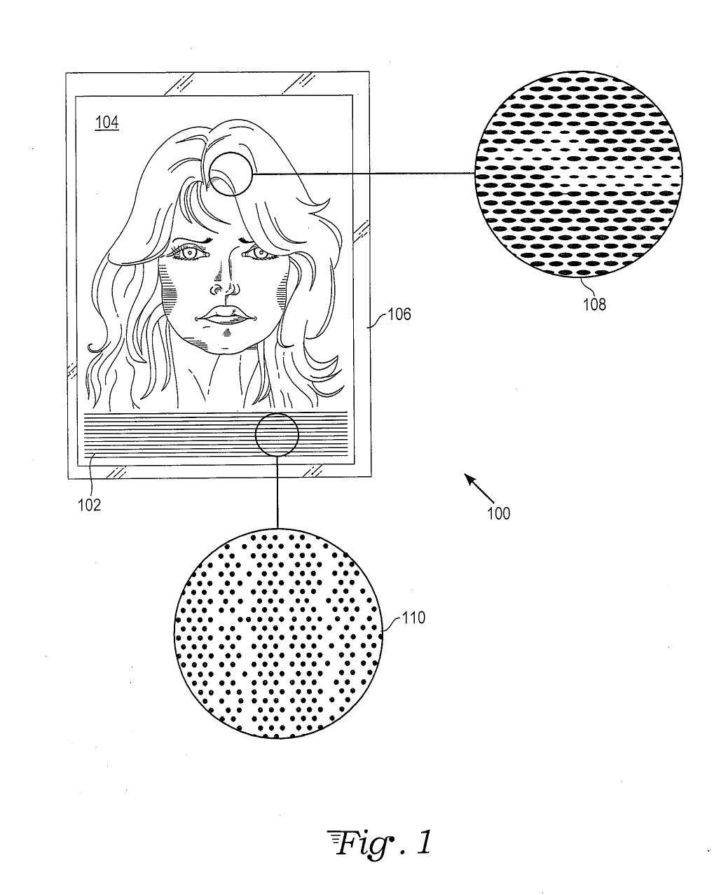

With reference to FIG. 1, an optically writable holographic card 100 that uses an optically writable holographic media in accordance with the present invention is herein disclosed. By substituting an optically writable material for the known reflective layer in an embedded hologram, the optically writable holographic media provides optical data writing, optical image writing and a durable embossed hologram made of the optically writable material, as described with reference to FIGS. 1-7.

The optically writable holographic card 100 shown in FIG. 1 has an optically writable data region 102, an optically writable image region 104, and an embossed hologram region 106, each of which is made of an optically writable material. A hologram may be embedded in the embossed hologram region 106, and the optically writable data region 102 and optically writable image region 104 may be personalized with information and an image unique to an individual card, e.g. as corresponding to an individual owner or user of the card. The optically writable holographic media is made and applied to the optically writable holographic card 100 in a method and using equipment that can be incorporated by card manufacturers. The optically writable holographic card 100 has an embedded hologram, is personalized, and has a media that can be made in diverse form factors and applied to a wide range of card body materials. The optically writable holographic media is recordable in variants of a current optical writer/optical reader, and includes optical recording of data and optical recording of high resolution images. Using high resolution optical writing, a type of conventional holographic image may be written or embedded in the optically writable image region 104. Further details of the optically writable holographic card, media and method will be described following a discussion about hologram types, layers and manufacturing processes.

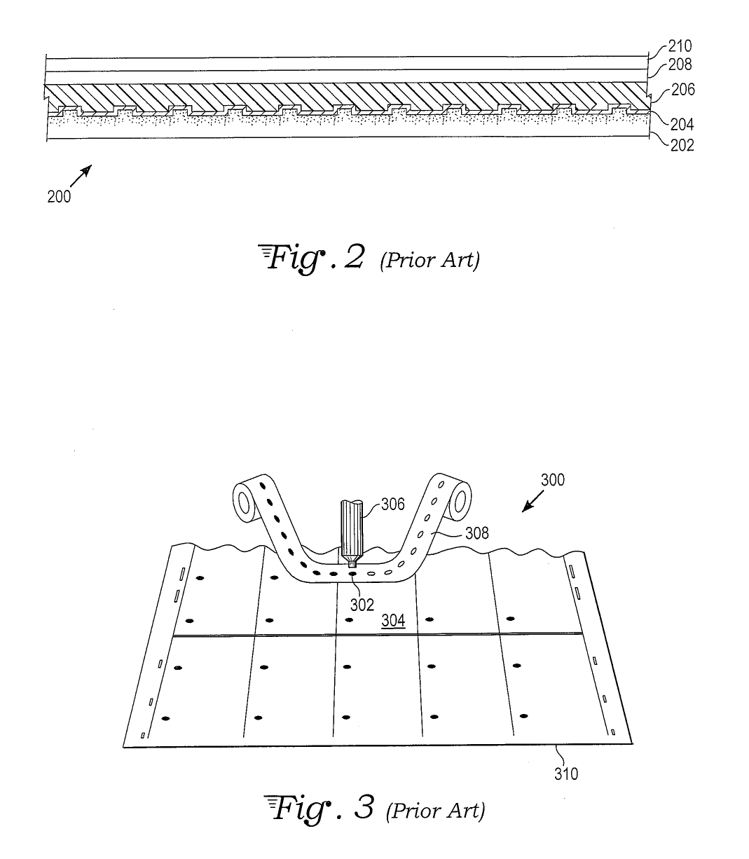

There are two major types of hologram materials, one as known for volume holograms and the other as known for embossed holograms. The optically writable holographic card 100 of FIG. 1 makes use of a modification of a known embossed hologram, the modification including constructing the reflective layer of the embossed hologram out of an optically writable material. Known volume holograms and embossed holograms are made by differing techniques, and neither known type of hologram described below with reference to FIGS. 2 and 3 is previously made of an optically writable material.

Volume holograms are reproduced photographically from a master hologram, and capture an holographic image using interference fringes throughout the depth and area of a high resolution photographic emulsion. Volume holograms typically display one diffracted color corresponding to the wavelength of the laser used in capturing the hologram, although bicolor and tricolor versions may mimic full spectrum color in the generated holographic image. Surface relief or embossed holograms are reproduced by stamping, pressing or molding processes from a master embossing die, and capture an holographic image using interference fringes recorded, e.g. with photoresists or photothermoplastics, and etched or otherwise impressed into an initially flat surface. Embossed holograms typically exhibit a rainbow effect when viewed in white light. Volume holograms generate or produce a higher-quality holographic image but are more expensive to manufacture, and embossed holograms generate or produce a lower-quality holographic image but are less expensive to manufacture. A hologram transfer foil is described in U.S. Pat. No. 7,101,644, to Toshine et al.

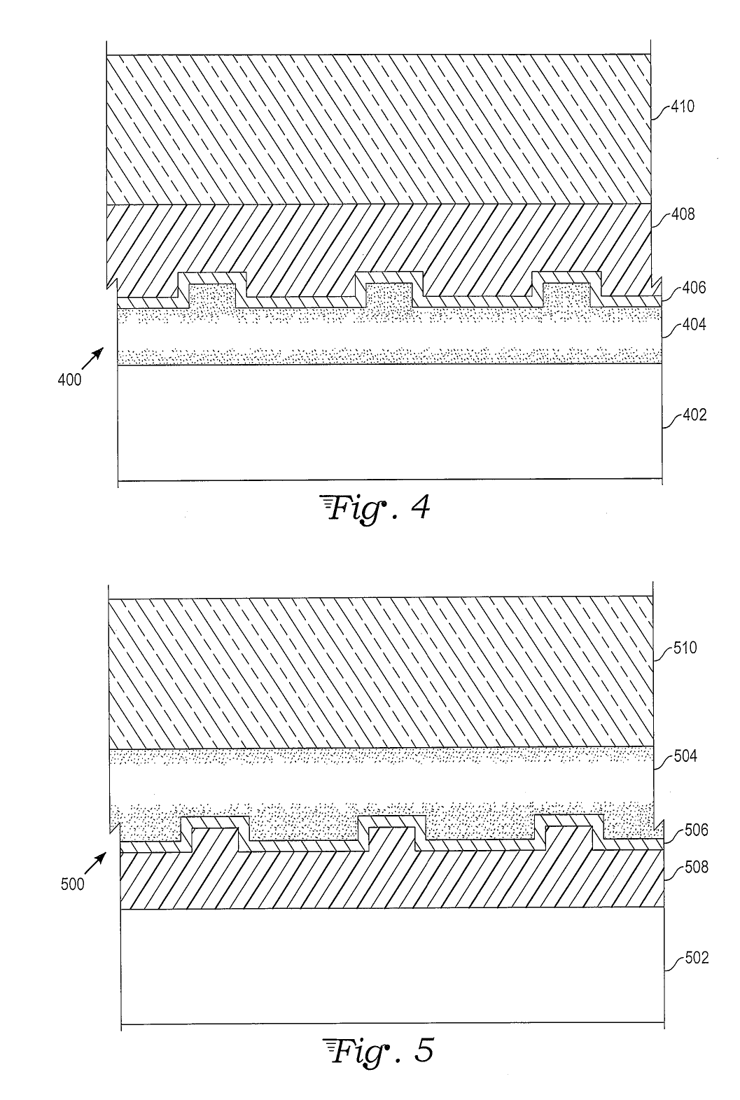

With reference to FIG. 2, embossed hologram layers 200 in an existing, known process for embossed holograms are shown. The existing embossed hologram layers 200 are modified to provide an optically writable holographic media, as will be further described with reference to FIGS. 4 and 5. Embossed holograms are also known as transfer holograms, as the holographic recording is mechanically transferred. FIG. 2 shows a heat transferred hologram patch, normally used for hologram underlay applications. Using a master embossing die (not shown), the hologram is embossed into a thin embossed acrylic layer 206. The ridges and spaces between ridges in the embossed acrylic layer 206 correspond to holographic interference fringes recorded on the master embossing die.

The embossed acrylic layer 206 is supported on a polyester film 210. A release layer 208 is formed between the embossed acrylic layer 206 and the polyester film 210. Typically, the embossed layer 206 is coated with an aluminum reflective layer 204, which conforms to the embossed layer 206. The aluminum reflective layer 204 is then covered with a heat activated adhesive layer 202. Transfer of the hologram to a substrate is achieved by hot stamping, which activates the heat activated adhesive layer 202. The hot melt adhesive from the heat activated adhesive layer 202 bonds the hologram to a substrate (not shown). Transfer of the hologram to the substrate is accompanied by a separation of the embossed acrylic layer 206 from the release layer 208 and the polyester film 210 support layer.

With reference to FIG. 3, an existing, known thermal bonding system 300 bonds an embossed hologram 302 to a substrate 304, such as an identification card. A thermal bonder 306 applies heat to the embossed hologram 302, releasing the embossed hologram 302 from the polyester film 308. Heat from the thermal bonder 306 melts the heat activated adhesive on the embossed hologram 302, and the embossed hologram 302 bonds to the substrate 304. The thermal bonding system 300 manufactures a sheet 310 of identification cards, which are then separated by a cutting process.

With reference to FIGS. 4 and 5, an optical recording, optically writable holographic media having an embossed hologram is created by substituting an optically writable layer or material for the known aluminum reflective layer 204 of the existing embossed hologram. As the standard aluminum reflective layer 204 of the existing embossed hologram is not an optically writable material, the standard existing embossed hologram is not made of optically writable material.

Optically writable layers in known, standard writable CD-ROM, writable DVD, erasable rewritable CD-ROM or erasable rewritable DVD processes and products, or optically writable media strips e.g. in security identification cards, may be substituted for the aluminum reflective layer 204. An organic laser receptive dye may be applied to the embossed acrylic layer 206 prior to the evaporated aluminum, i.e. after the embossed acrylic layer is created and before the aluminum layer is added, or between the embossed acrylic layer and the aluminum layer, so that the combined organic laser receptive dye and the aluminum are then optically writable. In a variation, an organic laser receptive dye is applied to the aluminum reflective layer 204 after the aluminum reflective layer 204 is applied to the embossed acrylic layer 206. Various types of optically writable materials and media which may be applied as a substitute for the aluminum reflective layer 204 include pit-forming media, bubble-forming media, color-changing media, erasable media, erasable pit-forming media, bump-forming media, phase change media and photochromic media. Other optically writable materials and layers may be devised by a person skilled in the art. A layer may have sub-layers or multiple layers making up a compound layer.

Optically writable media is written to (by optical writing) using a focused laser beam to record spots corresponding to data bits or image pixels on the media. Optically writable media is read (by optical reading) using a focused laser beam, reflected by the media, to detect the spots written on the media. The terms optical writing and optical recording, as applied to data and images, e.g. optically written or recorded data and optically written or recorded images, are herein used as equivalent in that optically writing or optically recording data or optically writing or optically recording an image involve optically writing spots to the optical media, the spots taking the form of reflectance changing areas of a type discussed above or known in the art.

When an optically writable media is read, changes in reflectivity corresponding to the ones and zeros written to the media are detected in the reflected focused laser beam. Optically writable media is inherently reflective. By replacing the aluminum reflective layer 204 in the embossed hologram layers 200 of FIG. 2 with an optically writable layer 406 of FIG. 4 or an optically writable layer 506 of FIG. 5, the optically writable holographic media layers 400 or 500 can reflect and diffract impinging light, and generate the holographic image associated with the holographic embossment.

An optically writable, embossed holographic media thusly created may take the form of an holographic OSM patch. In one embodiment, the holographic OSM patch is transferred to a clear protective layer, with the final holographic OSM being viewed through the heat activated adhesive. In a further embodiment the holographic OSM patch is transferred to a substrate and a clear protective layer is subsequently bonded to the acrylic side.

With reference to FIG. 4, a cross-section view of optically writable holographic media layers 400 is shown. The layers 400 include a substrate 402, which may be a card e.g. an identification card, an embossed acrylic layer 404, an optically writable layer 406, a transfer adhesive layer 408 which should be transparent, and a transparent layer 410, which may be a transparent cover sheet. In an example process, the acrylic layer 404 is embossed, using a master embossing die that has the recorded holographic interference fringes corresponding to the holographic image. An optically writable layer 406 is applied to the embossed acrylic layer 404, and conforms to the holographic embossment of the embossed acrylic layer 404. A transfer adhesive layer 408 is applied to the optically writable layer 406. Using heat, the transfer adhesive layer 408 is partially melted and bonded to a transparent layer 410. Subsequently, the flat, non-embossed side of the embossed acrylic layer 404 is bonded to a substrate 402. The holographic image is viewed through the transparent layer 410, in response to illuminating the optically writable layer 406 through the transparent layer 410. The optically writable layer 406 exhibits the holographic embossment of the embossed acrylic layer 404, as viewed through the transparent layer 410 and the transfer adhesive layer 408, and is thus able to generate or produce the holographic image.

With reference to FIG. 5, a cross-section view of optically writable holographic media layers 500 is shown, as a variation of the optically writable holographic media layers 400 of FIG. 4. The layers 500 include a substrate 502, which may be a card, e.g. an identification card, a transfer adhesive layer 508, an optically writable layer 506, an embossed acrylic layer 504, and a transparent layer 510, which may be a transparent cover sheet. In an example process, the acrylic layer 504 is embossed, using a master embossing die that has the recorded holographic interference fringes corresponding to the holographic image. An optically writable layer 506 is applied to the embossed acrylic layer 504, and conforms to the embossment of the embossed acrylic layer 504. A transfer adhesive layer 508 is applied to the optically writable layer 506. Using heat, the transfer adhesive layer 508 is partially melted and bonded to a substrate 502. Subsequently, the flat, non-embossed side of the embossed acrylic layer 504 is bonded to a transparent layer 510. The holographic image is viewed through the transparent layer 510, in response to illuminating the optically writable layer 506 through the embossed acrylic layer 504. The optically writable layer 506 exhibits the holographic embossment of the embossed acrylic layer 504, as viewed through the transparent layer 510 and the embossed acrylic layer 504, and is thus able to generate or produce the holographic image.

In variations, other materials, sequences or layers may be devised. A master embossing die may be a positive or negative, i.e. inverse version of the initially recorded holographic interference fringes, depending on whether the hologram is viewed through the embossed acrylic layer 504 as in FIG. 5 or is viewed through the transparent adhesive layer 408 as in. FIG. 4. Equivalently or in variations, the use of a positive or negative master embossing die may depend on which face is viewed of an optically writable material exhibiting an holographic embossment, e.g. optically writable layer 406 or 506.

An embossed layer such as embossed acrylic layer 404 or embossed acrylic layer 504 may be produced as associated with an holographic image in various ways as devised by a person skilled in the art. The embossed layer is produced using a master embossing die that has a surface relief corresponding to holographic interference fringes associated with the holographic image. In a first example process, an acrylic or other moldable material layer is heated and a master embossing die is pressed or stamped upon the acrylic layer, impressing the embossment upon the acrylic or other material layer. In a second example process, acrylic or other moldable material is melted and molded in a layer upon the master embossing die, transferring the embossment to the molded material, which is then cooled and retains the embossment. In a third example process, a photopolymerization (2p) process is used. A UV curable formulation, e.g. a photopolymer in liquid form, is applied to the master embossing die, and ultraviolet (UV) light cures the applied formulation by photopolymerization. The cured layer retains the embossment as an embossed layer, in this type of UV cured molding process. These and other processes can produce an embossed layer, i.e. a layer having an embossment, corresponding to or associated with an holographic image. Such a stamped, pressed or molded layer has an holographic embossment.

Conforming the optically writable layer to the embossed layer imparts a surface relief to the optically writable layer corresponding to holographic interference fringes associated with the holographic image. Thus, the optically writable layer takes on and retains an holographic embossment. As a result of the holographic embossment on the optically writable layer and the inherent reflectivity of the material of the optically writable layer, the holographic image is generable by the holographically embossed optically writable layer.

While viewing a hologram through a heat transfer adhesive e.g. the transfer adhesive layer 408 of FIG. 4 may be visually acceptable, a UV curable transparent adhesive may provide improved optical quality, as by having fewer optical defects. Various adhesives may be devised. An adhesive should be transparent if the hologram is viewed through the adhesive.

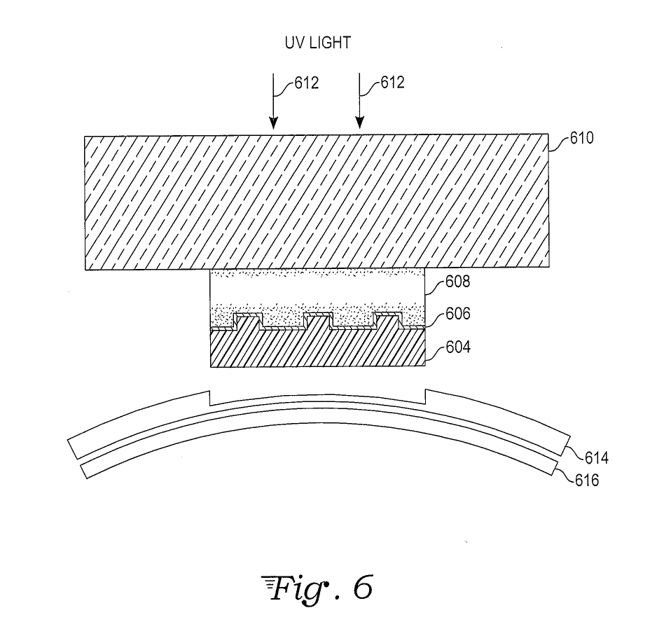

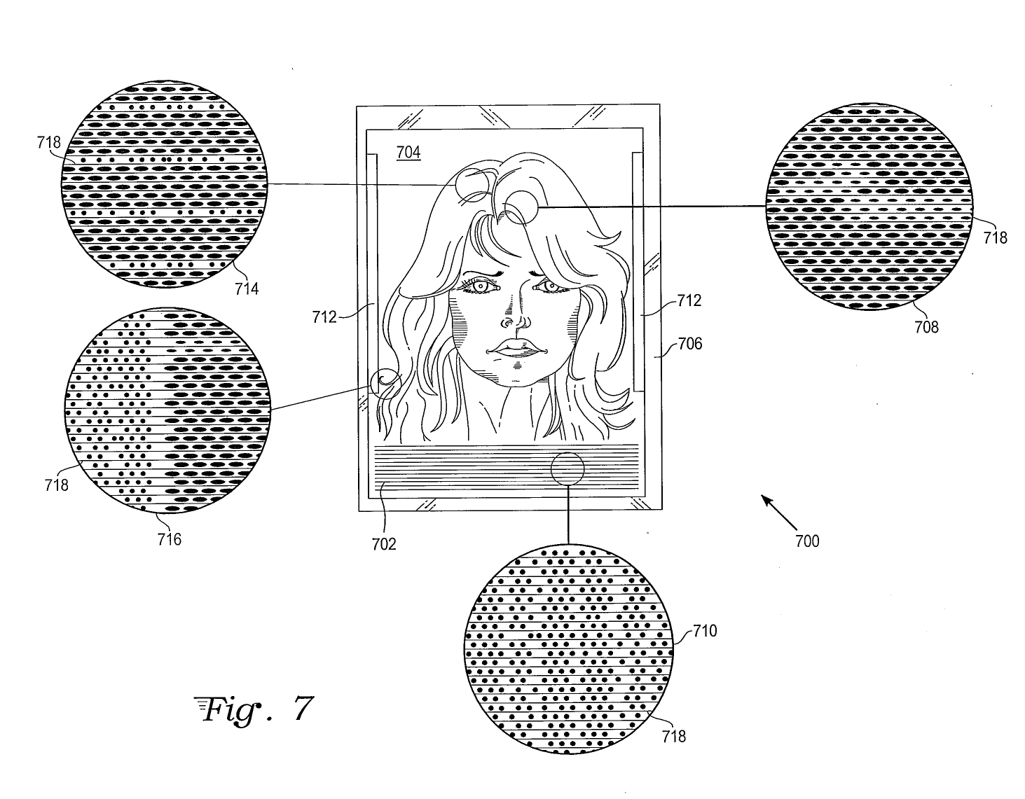

With reference to FIG. 6, a UV curable transparent adhesive 608 is used to adhere an optically writable holographic media to a transparent layer 610. In a first example process, the UV curable transparent adhesive 608 is applied to the transparent layer 610, and the optically writable layer 606 conforming to the holographically embossed layer 604 is brought into contact with the UV curable transparent adhesive 608. In a second example process, the UV curable transparent adhesive 608 is applied to the optically writable layer 606, and the transparent layer 610 is brought into contact with the UV curable transparent adhesive 608. Once the layers are brought together, UV light 612 is applied, through the transparent layer 610, to cure the UV curable transparent adhesive 608. After the layers are bonded, the polyester substrate 616 and the release layer 614 are removed from the optically writable holographic media, e.g. by peeling off the polyester substrate 616 and release layer 614 from the holographically embossed layer 604.

An optically writable holographic media may be applied to or become part of a further product, such as an identification card, in various processes or articles devised by a person skilled in the art. In a first example, the media is applied in patches, as by a variation of the thermal bonding system 300 of FIG. 3. In a second example, the media is applied as a continuous film. In a third example, areas of an article that are to be left uncoated are masked, and a variation of the above-described processes is applied to the unmasked areas. In a fourth example, a variation of the above-described processes is applied to an article, and areas are etched away to produce various regions. In a fifth example, the media is produced and sold in the form of a sheet ready for lamination into a card structure. In a sixth example, the media is produced and sold in the form of patches or regions on a transfer tape. In a seventh example, the media is produced and sold in the form of a transfer tape having recordable media, predefined high resolution images and predefined conventional holograms. Further variations may be devised.

With reference to FIGS. 1 and 7, examples are shown of optically writable holographic cards that have optically writable holographic media. The optically writable holographic media may be manufactured in conjunction with the card, or separately and applied to the card.

In FIG. 1, the optically writable holographic card 100 has an optically writable holographic media applied to the card such as by laminate to or further processing of a substrate card, or is made of the optically writable holographic media. In one example, the optically writable material is write once, read mostly or many (WORM). In a further example, the optically writable material is read/write (R/W) and erasable. An optically writable data region 102 supports optical data writing as from existing or further developed optical media data writing devices. A close-up view of optically written data 110 shows microscopic spots corresponding to laser-written bits. An optically writable image region 104 supports optical writing of images, as by writing ones and zeros to create light and dark spots, or dithering, or writing grayscale spots, corresponding to a digitized image or regions or pixels thereof. Vector or raster processes may be used. In identification cards the image may be a photograph of a person. A close-up view of a portion of the optically written image 108 shows microscopic spots corresponding to the laser-written image portion. An embossed hologram region 106 has the optically writable material expressing the holographic embossment from a master embossing die, as described. The embossed hologram region 106 is shown as a border of the optically writable holographic card 100, but may have another shape or occupy another region of the optically writable holographic card 100 or other article.

In FIG. 7, the optically writable holographic card 700 has an optically writable holographic media applied to the card or is made of the optically writable holographic media. An optically writable data region 702, a close-up view of optically written data 710, an optically writable image region 704, a close-up view of the optically written image 708, an embossed hologram region 706, and use of write once, read mostly or read/write and erasable material are similar to the corresponding features and views of FIG. 1.

Further, the optically writable holographic card 700 has embedded digital data 714 in the image area. In the example shown, digital data is written to every sixth track or row e.g. in one track or row out of six, and is shown with a spot size smaller than the spot size for the image, with image spots making up the remaining five tracks. Embedding digital data in an image degrades the image slightly, and image degradation is adjustable by varying the number or ratio of data tracks or rows in an image area, or the ratio of digital data bits or spots to image pixels or spots.

Still further, the optically writable holographic card 700 has an embossed track number region 712, in which the tracks are numbered, and the track numbering is expressed in embossing. The tracks 718 are physically delineated with embossing. As the close-up view of the intersection between embossed track numbers and laser written image 716 shows, the embossed track numbers may be written with spot sizes smaller than the spot sizes for the laser-written image. In variations, spot sizes for either data or image may be larger or smaller than or equal to other spot sizes.

FIGS. 1 and 7 show optically writable data regions 102 and 702, optically writable image regions 104 and 704 and embossed hologram regions 106 and 706, all of which are on an optically writable holographic media. Equivalently, FIGS. 1 and 7 show a large area of optically writable holographic media, which may be subdivided into writable data regions, writable image regions and embossed hologram regions. In a variation, an embossed hologram region supports optical data writing and/or optical image writing.

In a further variation, an optically writable image area supports high-resolution optical recording of closely spaced laser-written spots in a pattern approximating holographic interference fringes. Such a process is related to known laser-engraved holograms, which employ a laser to engrave a material e.g. a plastic card in a pattern approximating holographic interference fringes. The optically written pattern generates an holographic image. In a variation, a high resolution photographic image is optically written to an optically writable image area and produces a semi-photographic image with light interference effects that may be partially holographic.

The optically writable holographic card 100 and related optically writable holographic media satisfy at least the following goals.

1) The provision of an inexpensive media capable of supporting the creation of “personalized embedded holograms”. The optically writable holographic media has an embedded embossed hologram, and may be personalized with an optically written image and optically written data.

2) A media capable of being applied to a card in diverse form factors rather than in stripes only as is the case for an existing, known card. The optically writable holographic media may be manufactured in various form factors.

3) A media capable of being applied to a wide range of card body materials. The optically writable holographic media may be manufactured integrally with or adhered to various materials such as used in cards and other products.

4) A media designed such that it can be applied using variations or portions of the equipment and techniques currently used for holograms, so that it could easily be incorporated by most card manufacturers. The method of making an optically writable holographic media and the resulting media are applicable to modifications of known equipment and techniques.

5) A media recordable in variants of the current reader writer such that a relatively low cost desktop system capable of producing personalized holograms could be offered. The optically writable holographic media and related optically writable holographic card supports optical writing using variations of known optical writing systems.

6) Extension of the product to include recording of data. The optically writable holographic card and related media support optical writing of data.

7) Extension of the product to include high resolution images and/or conventional holographic images in addition to the personalized embedded hologram. The optically writable holographic card and related media support optical writing of images and optical writing of a type of image having holographic properties.

What is claimed is:

1. A method of making an optically writable holographic media, the method comprising:
producing an holographic embossment associated with an holographic image; and
conforming an optically writable layer to the holographic embossment; wherein
the holographic image is viewable in response to illuminating the optically writable layer; and
the optically writable layer is optically readable.

2. The method of making an optically writable holographic media of claim 1, wherein producing an holographic embossment includes making or using a master embossing die having a surface relief corresponding to holographic interference fringes associated with the holographic image.

3. The method of making an optically writable holographic media of claim 1, wherein conforming the optically writable layer to the holographic embossment imparts a surface relief to the optically writable layer corresponding to holographic interference fringes associated with the holographic image.

4. The method of making an optically writable holographic media of claim 1, wherein producing the holographic embossment includes pressing or stamping a master embossing die into a moldable layer, or molding the moldable layer onto the master embossing die.

5. The method of making an optically writable holographic media of claim 1, wherein producing the holographic embossment includes using ultraviolet light to cure a photopolymer applied to a master embossing die, the cured photopolymer forming a holographically embossed layer having the holographic embossment.

6. An optically writable holographic media comprising:
an holographically embossed first layer having an embossment corresponding to an holographic image; and
an optically writable, optically readable second layer that conforms to the embossment;
wherein the holographic image is generable by the second layer.

7. The optically writable holographic media of claim 6 wherein the first layer includes an embossed acrylic layer.

8. The optically writable holographic media of claim 6 wherein the first layer includes an ultraviolet light cured photopolymer.

9. The optically writable holographic media of claim 6 further including an adhesive layer.

10. The optically writable holographic media of claim 9 wherein the adhesive layer includes a heat transfer adhesive.

11. The optically writable holographic media of claim 9 wherein the adhesive layer includes an ultraviolet light cured photopolymer.

12. The optically writable holographic media of claim 6 further including a release layer.

13. The optically writable holographic media of claim 6 further including a transparent layer.

14. The optically writable holographic media of claim 6 wherein the second layer includes a material that is color-changing, phase-changing, photochromic, write once or erasable, or forms bubbles, pits or bumps in response to optical writing.

15. An optically writable holographic card comprising:
a card; and
a media region on the card that includes an optically writable material having an holographic embossment such that an holographic image related to the holographic embossment is producible by the optically writable material.

16. The optically writable holographic card of claim 15 wherein the optically writable material supports optically written digital data and an optically written image.

17. The optically writable holographic card of claim 15 wherein the optically writable material includes an optically written image having embedded digital data.

18. The optically writable holographic card of claim 15 wherein the optically writable material has embossed track numbers.

19. The optically writable holographic card of claim 15 wherein the optically writable material has embossed track delineations.

20. The optically writable holographic card of claim 15 wherein the optically writable material has an optically written pattern that generates an holographic image.
